(19) United States
(12) Patent Application Publication
(10) Pub. No.: US 2007/0169037 A1
(43) Pub. Date: Jul. 19, 2007

(54) Command center system and method

(76) Inventors: Lenin Kumar Subramanian, Palo Alto, CA (US); Yue Fang, Mountain View, CA (US)

Correspondence Address: RICHARD F. JAWORSKI;Cooper & Dunham LLP, 1185 Avenue of the Americas, New York, NY, 10036, US

(21) Appl. No.: 11/598,390

(22) Filed: Nov. 13, 2006

Related U.S. Application Data
(60) Provisional application No. 60/738,235, filed on Nov. 18, 2005.

(51) Int. Cl. G06F 9/45

(52) U.S. Cl. 717/143; 717/135

(57) ABSTRACT

A method for interacting with a computer application includes receiving, from a user, an input string from an input field, parsing the input string to identify a command token, validating user authorization to execute the identified command token and executing at least a portion of the computer application based on the identified command token.

### REFERENCE TO RELATED APPLICATION

This application is based on and claims the benefit of Provisional application Ser. No. 60/738,235 filed Nov. 18, 2005, the entire contents of which are herein incorporated by reference.

### BACKGROUND OF THE DISCLOSURE

1. Field of the Disclosure

The present disclosure relates generally to a command center and, more specifically, to a command center system and method.

2. Description of the Related Art

There are various types of systems that have been developed to make it easier for inputting or selecting information on a computer. These systems include various types of keyboards, mouse systems, voice detection systems, touch screens, etc. However, even with the technological advances in these types of systems, inputting or selecting information can still be labor intensive and time consuming. Applications often require many “clicks” to navigate to a desired portion of the application. For example, to enter a command such as “Create Order for John Doe,” a user may have to click an “Orders” tab, click a “Create Order” button, click to choose a Sales area, click to choose the Business partner (John Doe), etc. Only then will the user be presented with the Order details screen allowing the user to enter the appropriate information.

Another example would be where an administrator wants to create a user and assign them to a certain role in a particular organization. In certain applications, the administrator can select a “Role” field which may be found, for example, using a F4-help button. Clicking on the F4-help button will display the organization tree. However, the administrator then still has to navigate the tree to pick the role under the particular section of the organization that the new user is to be added to.

Yet another example would be adding a product to an order while editing. In certain applications, the user can click an “Add Item” button. The computer system will then perform a server trip for page refreshes with a new entry in the table layout. Assuming that the user knows the product name but does not know the product number, the user must then launch the F4-help menu to search for the product number of the product and then select that product number, etc.

Considering the number of clicks required and the time required for all of the server trips, page refreshes, etc, it will be appreciated that the time and effort involved with entering commands can be substantial. This applies not only to commands, but also to other types of control functions such as, for example, adding information to a form or file, modifying a form or file, etc.

### SUMMARY

A method for interacting with a computer application comprises receiving from a user, an input string from an input field, parsing the input string to identify a command token, validating user authorization to execute the identified command token and executing at least a portion of the computer application based on the identified command token.

A computer recording medium including computer executable code for interacting with a computer application comprises code for receiving from a user, an input string from an input field, code for parsing the input string to identify a command token, code for validating user authorization to execute the identified command token and code for executing at least a portion of the computer application based on the identified command token.

A system for interacting with a computer application comprises a receiving module for receiving from a user, an input string from an input field, a parsing module for parsing the input string to identify a command token, a validation module for validating user authorization to execute the identified command token and an execution module for executing at least a portion of the computer application based on the identified command token.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram of a computer system capable of implementing various embodiments of the present disclosure;

FIG. 2 is a page displayed on a computer screen according to embodiments of the present disclosure;

FIGS. 3A and 3B are user modification screens according to an embodiment of the present disclosure;

FIGS. 4A-4C are screen shots for describing embodiments of the present disclosure;

FIG. 5 is a screen shot for explaining the use of context sensitive commands; and

FIG. 6 is a flow chart for describing embodiments of the present disclosure.

### DETAILED DESCRIPTION

In describing embodiments of the present disclosure illustrated in the drawings, specific terminology is employed for sake of clarity. However, the present disclosure is not intended to be limited to the specific terminology so selected and it is to be understood that each specific element includes all technical equivalents which operate in a similar manner.

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

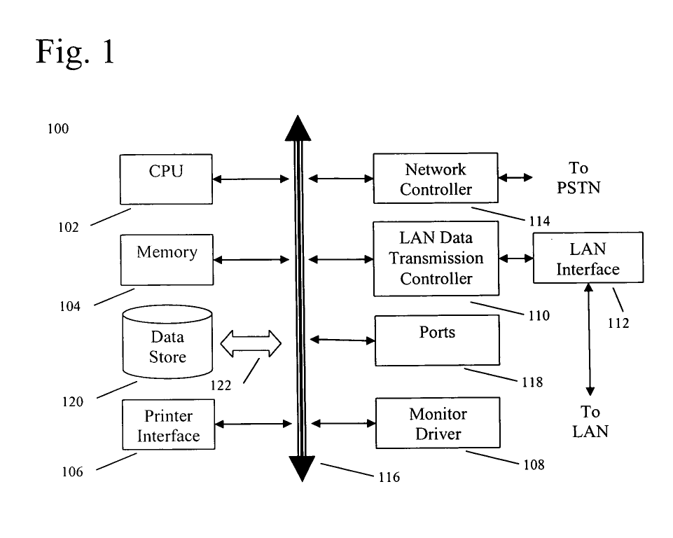

FIG. 1 shows an example of a computer system 100 which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input device ports 118 (for example, a keyboard, mouse etc.). As shown, the system 100 may be connected to a database 120, via a link 122.

The computer system 100 is merely exemplary. The specific embodiments described herein are illustrative, computer system(s) as referred to herein may include(s) individual computers, servers, computing resources, networks, etc., and many variations can be introduced on these embodiments without departing from the spirit of the disclosure or from the scope of the appended claims.

Embodiments of the present disclosure ease the time and effort involved navigating different parts of an application. According to an embodiment of the present disclosure, an input field and an execute button are provided on a user's computer screen. According to various embodiments of the present disclosure, the input field and execute button can always be available for the end-user on all screens or can be made available upon entry of one or more predefined key strokes such as, for example, by pressing an F4 help button.

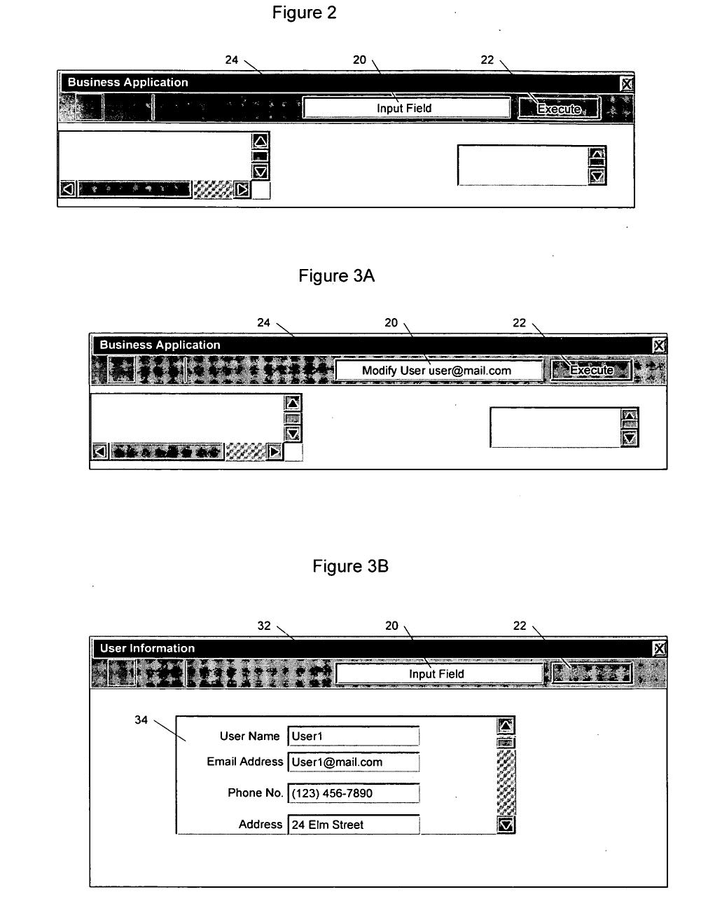

According to an embodiment of the present disclosure as shown in FIG. 2, an input field 20 and an execute button 22 are provided in the top right side corner of the page 24 being displayed. In the input field 20, the user can type commands which will launch the section of the application which the user wants. For example, if an Administrator wants to create a user, the user types “Create User” in the input field 20 and on executing the command (e.g., by clicking on the execute button 22), the User creation page is immediately presented to the user. This way, the Administrator is saved from having to perform all of the clicks usually associated with navigating to the User creation screen. According to other embodiments of the present disclosure, only the input field is provided. Pressing the “ENTER” button after entering the information in the input field will act as a launch or execute button.

Embodiments of the present disclosure may also be applied to modification of user information. For example, by typing in “Modify user user1@mail.com” in the input field 20 and upon clicking on execution button 22, a User Information screen 32 presenting information 34 for User 1 as shown in FIG. 3B is displayed. The user information can then be modified in the usual manner by moving a curser (not shown) and clicking on the appropriate information. This saves the user time from having to go to the search screen and having to perform a search based on the desired email address and only then getting to edit the details of the data.

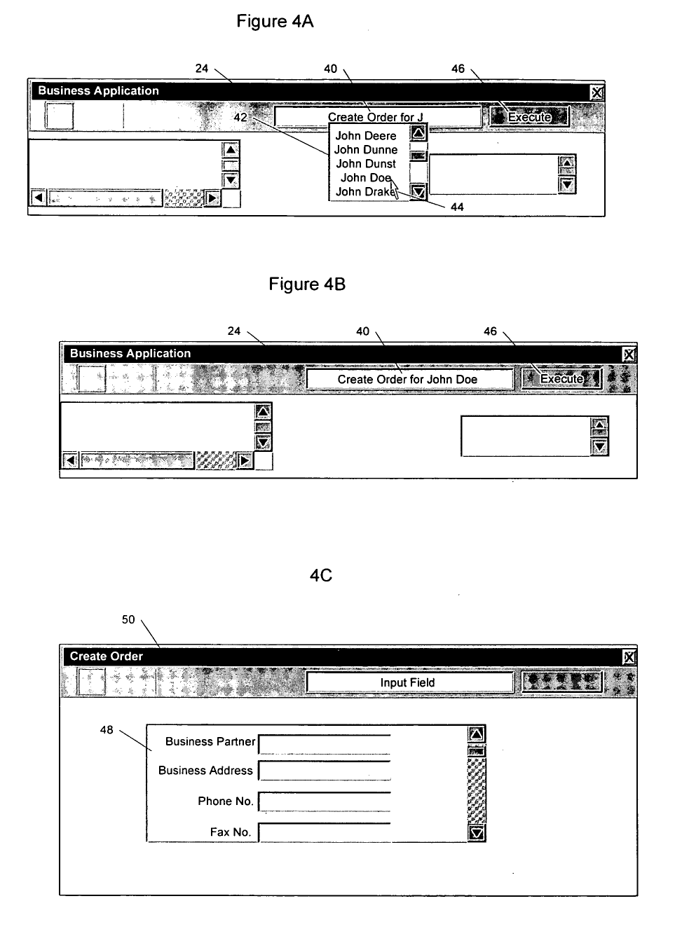

According to an embodiment of the present disclosure, when the user starts typing a command in the input field 30, the user can get help with the commands. For example, the help can be in the form of a dropdown screen provided below the input field which will help guide the user through the command entry. Depending on the command, the dropdown screen can present appropriately related business information. For example, a Sales person may want to create an order for a business partner John Doe. The sales person starts to type “Create Order for J” into input field 40 and immediately following entry of the character “J”, all business partners having names beginning with the letter “J” will be shown in the dropdown screen 42, as shown in FIG. 4A. The sales person can move curser 44 to the correct name and click on it. This will automatically update the input field 40 with the correct name, as shown in FIG. 4B. The “Create Order” command for user John Doe will then be executed when the user clicks execute button 46. Upon execution, a Create Order details page 50 with appropriate context information 48 will be retrieved and displayed as shown in FIG. 4C. Utilizing embodiments of the present disclosure, the user is thus saved from having to navigate to the Order section, click on the create button, and then choose the business partner (which might involve a search screen and selection) and only then being able to start filling in the details.

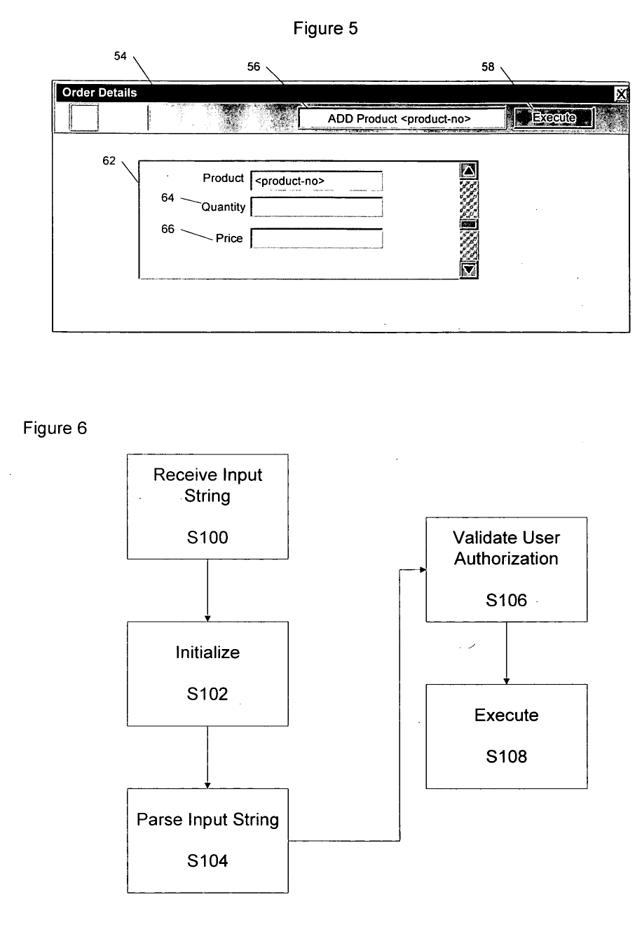

According to an embodiment of the present disclosure, the user can execute commands which are specific to certain context. For example, using a context sensitive command, if the user is in an “Order Details” screen 54 as shown in FIG. 5 and wants to add products, a sold-to-party, ship-to-party, etc., the user can type a context sensitive order command into the input field 56 and click the execute button 58. For example, to add a product to an order when in an “Order Details” screen, the user types “ADD Product <product-no>” into the input field 56 and clicks the execute button 58. The product <product-no> is then added to the order and can be displayed in details window 62, The user can then insert quantity 64 and price 66 information as appropriate. To add a sold-to party, the user types “ADD Sold-to <sold-to-party number>” into the input field 50 and clicks the execute button 52. The party <sold-to-party number> is then added to the order. To add a ship-to-party, the user types “ADD Ship-to <ship-to-party number>” into the input field 50 and clicks the execute button 52. The <ship-to-party number> is then added to the order.

Various operations can be performed when a command is executed. For example, according to an embodiment of the present disclosure, the user can automatically be sent a confirmation via email acknowledging that the change has been made to the order. According to another embodiment, a copy of the order can be displayed to the user so that the user can immediately confirm that the change has been made and providing the user an option to print the new order if desired. According to yet another embodiment of the present disclosure, the changes to the order can be highlighted on the displayed and/or printed order for ease of reference so that the user can easily view the changes that have been made to the order. The user is thus saved from having to search through the product master list for the product he already knows or through the customer master list for the customer he is already aware of and then make the changes to the order.

Examples of a basic set of commands that can be supported include transactional commands such as Create, Modify, Copy and Show and navigational commands such as Go-to or Launch, etc. The commands can be configured via a design time user interface. Multiple profiles can have different command configurations by creating and maintaining the configurations for each profile. A design time user interface can be used to get the different types of configuration information for the different commands. Configurations for Commands can include a Name of a Business object, an Authorization of permission profile (backend information), Parameters and a Target to be launched on execution, etc. The name of the business object is the name that will appear for the user in the help screen and the form that it is expected. According to an embodiment of the present disclosure, no spaces are allowed. For example, for a business object “Business Partner” to be associated with a command, it should be maintained as token “Business_Partner” or “BusinessPartner”. Parameters can be maintained with details about the query object, query parameter and the display parameter. The query object is used to query for help values as the user enters information and the display parameter is the one which gets shown in the help text. There should be a one to one correspondence between query parameter and the display attribute. In the query parameter field, the user can specify multiple parameters separated by commas and have corresponding commas separate display attributes. In this way, the command can process on values like “John Doe” where last_name and first_name are query parameters and display attributes respectively.

At runtime, a runtime model is initialized based on the profile and the user information. During this process, a tree-model is generated out of design-time data and services are initialized. The user information is used to make the authorization checks, to see what commands the user is permitted to execute and the profile is used to get the associated business objects for the command-set and for service initialization.

The flow chart shown in FIG. 6 will now be used to describe an embodiment of the present disclosure. After receiving an input string input by a user from an input field (Step S100), the system is initialized (Step S102). Initialization is a static method that initializes the system based on the profile and user details. The initialization process generates a tree model from the design-time information that is used for token parsing. The tree-model generated includes a root node that contains a list of all possible command tokens for the user and the profile. For each possible command token, there is a child node which includes the business objects used to execute the commands. The child nodes in turn contain for each business object a grandchild node which has information about the parameters, etc. Each of the business object nodes includes information about a command. The system then parses the input string to identify a command token (Step S104) and validates user authorization to execute the identified command token (Step S106). The system then executes at least a portion of the computer application based on the identified command token (Step S108). According to an embodiment of the present disclosure, when the system parses the command string, it generates a supporting help value that can be provided to the user. For example, according to an embodiment of the present disclosure, the system will present a predetermined number (e.g., the top seven) of help values which get converged as and when the user input to the input field approaches a specific command. If there are any errors in the input field, an appropriate message will be displayed to the user. For example, a pop-up message window that shows the message can be displayed to the user.

According to embodiments of the present disclosure, there may be specific syntax requirements for business data entered with a command. For example, where the user wants to see the details of a Business partner John Doe, in order for the parser to understand this as data that consists of both first name and last name, the user should enter following:
Show Business_Partner “John,Doe”

In this way it is clear to the parser that “John, Doe” as whole is one data token where first name is separated by a comma with the last name. Another example would be for creating a user for a position in the Organizational Unit. To create a user in the Global Sales Unit for the position Sales Manager, the command would be:
Create User for “Sales Manager,Global Sales”

In this way, the parser treats Sales Manager and Global Sales as one data token with two parameter information (comma separated).

The following are examples of some command structures that may be used according to embodiments of the present disclosure:

1. Create Order

2. Create Order for “<BusinessPartner like lastname, first<Name>”

3. Create Order with “<ProductId like D-1100)”

4. Create User for “<sales_position, sales_org>”, etc.

The following are examples of some event structures that may be used according to embodiments of the present disclosure:

1. Add “<product_id>” [In Orders context]

2. Add “<contact_person like lastname,firstname>” [Appointments]

Embodiments of the present disclosure thus provide an easy and efficient way to navigate different parts of an application by providing an input field and an execute button on a user's computer screen. The input field and execute button allow a user to navigate an application in fewer keystrokes and with fewer page refreshes than previously possible.

According to an embodiment of the present disclosure, end-users can navigate to any part of an application with just a click of a button. Embodiments of the present disclosure are also applicable in application where there is, for instance, an F4 help button that opens an input field. This input field can be used to enter information for navigating to appropriate portions of the applications as desired.

The present embodiments can be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the present disclosure can be performed by one or more programmable processors executing a computer program to perform functions of the invention by operating on input data and generating output. Method steps can also be performed by, and apparatus of the disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to t he user can be any form of sensory feedback, e.g., visual feedback, auditory feedback, or tactile feedback; and input from the user can be received in any form, including acoustic, speech, or tactile input.

The present embodiments can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the present disclosure, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

The present embodiments have been described in terms of particular embodiments. Other embodiments are within the scope of the present disclosure. For example, although the present embodiments have been described as a component in a larger system, it can also be implemented in other systems or as a stand-alone system.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments maybe combined with each other and/or substituted for each other within the scope of this disclosure and appended claims.

What is claimed is:

1. A method for interacting with a computer application comprising:
receiving, from a user, an input string from an input field;
parsing the input string to identify a command token;
validating user authorization to execute the identified command token; and
executing at least a portion of the computer application based on the identified command token.

2. The method as recited in claim 1, wherein the input string comprises data tokens used to enter information into the input field.

3. The method as recited in claim 1, wherein the executing is performed in response to receiving an execute input from the user.

4. The method as recited in claim 1, further comprising providing the user with syntax help when the user is inputting an input string into the input field.

5. The method as recited in claim 4, wherein the syntax help comprises presenting the user with a predetermined number of help values which get converged as and when the user input to the input field approaches a specific command.

6. The method as recited in claim 1, wherein a tree model is generated for token parsing to identify the command token.

7. The method as recited in claim 6, wherein for each possible command token, there comprises in the tree model a business object used to execute a command.

8. The method as recited in claim 7, wherein each business object comprises information about the command.

9. A computer recording medium including computer executable code for interacting with a computer application comprising:
code for receiving, from a user, an input string from an input field;
code for parsing the input string to identify a command token;
code for validating user authorization to execute the identified command token; and
code for executing at least a portion of the computer application based on the identified command token.

10. The computer recording medium as recited in claim 9, wherein the input string comprises data tokens used to enter information into the input field.

11. The computer recording medium as recited in claim 9, wherein the executing is performed in response to receiving an execute input from the user.

12. The computer recording medium as recited in claim 9, further comprising providing the user with syntax help when the user is inputting an input string into the input field.

13. The computer recording medium as recited in claim 12, wherein the syntax help comprises presenting the user with a predetermined number of help values which get converged as and when the user input to the input field approaches a specific command.

14. The computer recording medium as recited in claim 9, wherein a tree model is generated for token parsing to identify the command token.

15. The computer recording medium as recited in claim 14, wherein for each possible command token, there comprises in the tree model a business object used to execute a command.

16. The computer recording medium as recited in claim 15, wherein each business object comprises information about the command.

17. A system for interacting with a computer application comprising:
a receiving module for receiving, from a user, an input string from an input field;
a parsing module for parsing the input string to identify a command token;
a validation module for validating user authorization to execute the identified command token; and
an execution module for executing at least a portion of the computer application based on the identified command token.

18. The system as recited in claim 17, wherein the input string comprises data tokens used to enter information into the input field.

19. The system as recited in claim 17, wherein the execution module executes at least the portion of the computer application in response to receiving an execute input from the user.

20. The system as recited in claim 17, further comprising a help module for providing the user with syntax help when the user is inputting an input string into the input field.

21. The system as recited in claim 20, wherein the syntax help comprises presenting the user with a predetermined number of help values which get converged as and when the user input to the input field approaches a specific command.

22. The system as recited in claim 17, further comprising an initialization module for generating a tree model used for token parsing to identify the command token.

23. The system as recited in claim 22, wherein for each possible command token, there comprises in the tree model a business object used to execute a command.

24. The system as recited in claim 23, wherein each business object comprises information about the command.
